(19) United States
(12) Patent Application Publication
(10) Pub. No.: US 2012/0128168 A1
(43) Pub. Date: May 24, 2012

(54) METHOD AND APPARATUS FOR NOISE AND ECHO CANCELLATION FOR TWO MICROPHONE SYSTEM SUBJECT TO CROSS-TALK

(75) Inventors: Baboo Vikrhamsingh Gowreesunker, Dallas, TX (US); Young Chun Kim, Austin, TX (US)

(73) Assignee: TEXAS INSTRUMENTS INCORPORATED, Dallas, TX (US)

(21) Appl. No.: 13/299,010

(22) Filed: Nov. 17, 2011

Related U.S. Application Data
(60) Provisional application No. 61/414,943, filed on Nov. 18, 2010.

(51) Int. Cl. H04B 3/20

(52) U.S. Cl. 381/66

(57) ABSTRACT

A method and apparatus for joint noise and echo cancellation of a two microphone system subject to cross-talk. The method includes estimating the reference output by removing the cross-talk and the estimated echo from the reference channel, when an echo is detected in the reference echo signal, adapting filters H13 and H23 by NLMS, when the estimated primary output includes speech, adapting filters H12 and H21 by de-correlation, when neither echo nor speech is detected, adapting filter H12 is adapted by NLMS, obtaining the primary output and the reference output by post-filtering of the estimated primary output and the estimated reference output, respectively, and utilizing the primary output and the reference output for canceling the echo and noise of a two microphone system subject to cross-talk.

### CROSS-REFERENCE TO RELATED APPLICATIONS

This application claims benefit of U.S. provisional patent application Ser. No. 61/414,943 filed Nov. 18, 2010, which is herein incorporated by reference.

### BACKGROUND OF THE INVENTION

1. Field of the Invention

Embodiments of the present invention generally relate to a method and apparatus for noise and echo cancellation for two microphone system subject to cross-talk.

2. Description of the Related Art

For the case of cross-talk, noise leakage and echo interference are common on primary and reference channel inputs. There is a need for removing interfering noise and echo from an acoustics system with two microphone inputs, which suffers from the problem of cross-talk.

### SUMMARY OF THE INVENTION

Embodiments of the present invention relate to a method and apparatus for joint noise and echo cancellation of a two microphone system subject to cross-talk. The method includes retrieving the primary microphone signal, the reference microphone signal and the reference echo signal, utilizing the retrieved primary microphone signal, the reference microphone signal and the reference echo signal to estimate the cross-talk and echo in reference channel, noise leakage and echo in primary channel, estimating the primary output by removing the noise leakage and the echo estimate from the primary channel, estimating the reference output by removing the cross-talk and echo estimate from the reference channel, when an echo is detected in the reference echo signal, adapting filters H13 and H23 by NLMS, when the estimated primary output includes speech, adapting filters H12 and H21 by de-correlation, when neither echo nor speech is detected, adapting filter H12 by NLMS, obtaining the primary output and the reference output by post-filtering of the estimated primary output and the estimated reference output, respectively, and utilizing the primary output to extract speech from a two microphone system subject to cross-talk, noise and echo.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an embodiment of a mixing model with cross-talk and echo from downlink;

FIG. 2 is an embodiment of a cross-talk resistant ANEC;

FIG. 3 is an embodiment of a cross-talk and noise leakage filter adaptation;

FIG. 4 is an embodiment of an echo filter adaptation;

FIG. 5 is an embodiment of a two channel Voice Activity Detector (VAD) outputs from primary and echo reference channel inputs; and

FIG. 6 is a flow diagram depicting an embodiment of a method for joint noise and echo cancellation for two microphone system subject to cross-talk.

### DETAILED DESCRIPTION

Described herein is a method and apparatus for joint noise and echo cancellation in multi-microphone setup, which includes an assumed mixing model for the mixtures including speech, noise and echo. In addition, a de-mixing algorithm is included to invert the mixing model. The algorithm may use four filters to estimate the mixing filters and Voice Activity Detector (VAD), which is used to obtain references for each filter adaptation. Thus, in one embodiment, a model-based algorithm is utilized, which simultaneously models cross-talk, noise leakage, and echo path and adaptively removes noise and echo from the primary microphone channel. In one embodiment, it is assumed that a clean reference of the echo is available, usually from the downlink.

Therefore, the method and apparatus may combine the adaptive problems of two microphone noise canceller and echo reduction into one algorithm. In one embodiment, two Voice Activity Detectors (VAD) are used to identify the presence of noise, speech and echo, which uses different adaptation strategies based on the presence of one of these activities. Furthermore, the noise reduction is robust to the presence of cross-talk between the two microphones.

As a result, the outcome shows strong noise cancellation performance, even for non-stationary noise such as babble, the integrated noise and echo cancellation design reduces potential interaction issues between the noise adaptation and echo cancellation, good echo cancellation performance in the presence of noise, and the implementation is possible both in time and frequency domain.

Hence, the algorithm shows a good performance of speech separation from a mixture input including echo and noise in cross-talk. Such an algorithm adds echo reference input from downlink signal to remove far-end echo on primary channel input. To build up the algorithm, an environmental mixing model is utilized for cases, such as, when mixtures include speech, noise and echo.

The mixing model may have some assumptions, such as, unity gain for direct paths and the other one is assuming the relation between primary-echo channel and reference-echo channel. In this assumption, echo from downlink signal influences to primary and reference channel inputs, but may not be affected by the opposite directions. Next, a de-mixing algorithm based on the mixing model is developed. Since the algorithm may utilize four filters to be adapted, filter adaptation method may be implemented.

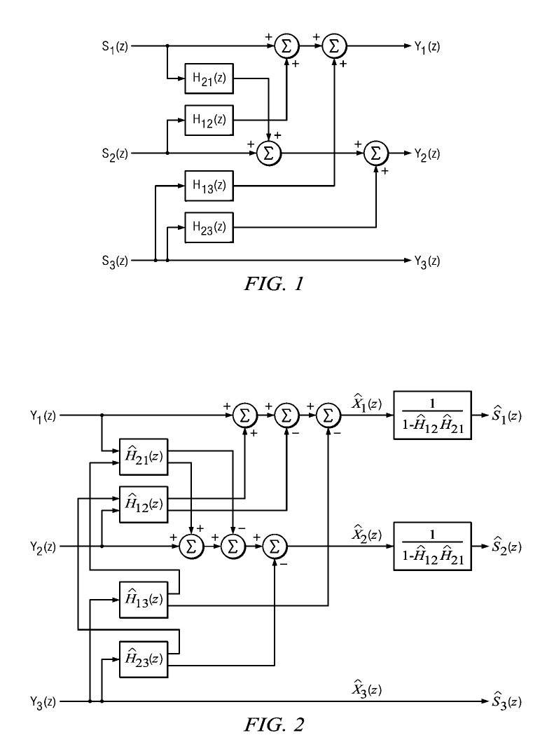

FIG. 1 is an embodiment of a mixing model with cross-talk and echo from down link in the Z-domain. FIG. 1 shows the proposed mixing model of mixtures—Y₁(z) and Y₂(z)—from three sources—S₁(z), S₂(z) and S₃(z)—obtained by two sensors and echo reference—S₃(z)—from downlink signal where S₁(z) is pure speech source, S₂(z) is pure noise source and S₃(z) is the echo reference respectively. Using a matrix form we can represent the mixing model such as Eq. (1).

$$[ \begin{matrix}{Y}_{1} ( z ) \\ {Y}_{2} ( z ) \\ {Y}_{3} ( z )\end{matrix} ] = [ \begin{matrix}1 & {H}_{12} ( z ) & {H}_{13} ( z ) \\ {H}_{21} ( z ) & 1 & {H}_{23} ( z ) \\ 0 & 0 & 1\end{matrix} ] [ \begin{matrix}{S}_{1} ( z ) \\ {S}_{2} ( z ) \\ {S}_{3} ( z )\end{matrix} ] \qquad ( 1 )$$

where H₁₂(z) is an FIR filter modeling the noise leakage from the reference channel to the primary channel, H₂₁(z) is the filter modeling the speech leakage from primary channel to the reference channel, H₁₃(z) is the echo reference leakage into primary channel and H₂₃(z) is the echo reference leakage that flow into the reference channel.

From the mixing model, Cross-talk Resistant Adaptive Noise and Echo Canceller (CTR-ANEC) de-mixing algorithm can be developed. By filter inversion operation, each source on primary and reference channel may be separated. Eq. (2) represents the de-mixing system by a matrix form. The echo reference input may not change and may remain the same as the echo reference input via the mixing and de-mixing systems.

$$[ \begin{matrix}{\hat{S}}_{1} ( z ) \\ {\hat{S}}_{2} ( z ) \\ {\hat{S}}_{3} ( z )\end{matrix} ] = \frac{1}{1 - {\hat{H}}_{12} {\hat{H}}_{21}} [ \begin{matrix}1 & - {\hat{H}}_{12} ( z ) & {\hat{H}}_{12} ( z ) {\hat{H}}_{23} ( z ) - {\hat{H}}_{13} ( z ) \\ - {\hat{H}}_{21} ( z ) & 1 & {\hat{H}}_{21} ( z ) {\hat{H}}_{13} ( z ) - {\hat{H}}_{23} ( z ) \\ 0 & 0 & 1 - {\hat{H}}_{12} ( z ) {\hat{H}}_{21} ( z )\end{matrix} ] [ \begin{matrix}{Y}_{1} ( z ) \\ {Y}_{2} ( z ) \\ {Y}_{3} ( z )\end{matrix} ] \qquad ( 2 )$$

Thus, the de-mixing algorithm may be implemented in a feed-forward fashion.

FIG. 2 is an embodiment of a cross-talk resistant ANEC. FIG. 2 is showing the block diagram and the whole system consists of four filters and six adders. In the CTR-ANEC, four FIR filters are used to estimate filter in mixing system. Since the four filters may be adapted at the same time, appropriate filter adaptation scheme is utilized. On the other hand, two of four filters may be different. In such a case, different filter adaptation schemes may be required. For example, H₁₂(z) and H₂₁(z) are cross-talk filter and noise leakage filter. Thus, they can be adapted using de-correlation method for separation of speech and noise. Whereas, H₁₃(z) and H₂₃(z) are echo filters, which any sort of filter adaptation method may be applied, such as, LMS, NLMS, RLS.

In one embodiment, NLMS is utilized due to its implementation convenience. Two channel VAD outputs from primary and echo channel inputs are referred for filter adaptation as well. Primary channel VAD may be activated during the time interval when there was speech input on the primary channel. Likewise, Echo channel VAD may be activated during the time when echo input was detected.

Cross-talk and noise leakage filters H₁₂(z) and H₂₁(z) may be estimated using de-correlation filter adaptation method using a steepest descent method. To be more specific, filter H₁₂(z) may be adapted during the time there is no speech input on the primary channel. Similarly, filter H₂₁(z) may be adapted while speech input is coming on the primary channel.

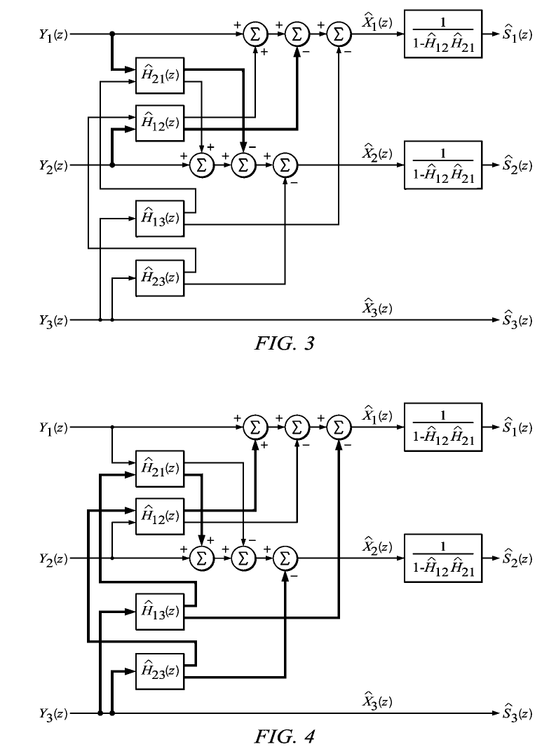

FIG. 3 is an embodiment of a cross-talk and noise leakage filter adaptation. FIG. 3 illustrates the filters when they are chosen to be adapted based on the VAD outputs. The filters update equations for H₁₂(z) and H₂₁(z) in time domain are the following. In one embodiment x₁(k) and x₂(k) are the time domain representations of X₁(Z), and X₂ (Z) respectively, h12 and h21 are the time domain representations of filters H₁₂(Z) and H₂₁(Z), Var(y) stands for variance of y, and α is an arbitrary constant between 0 and 1. N1 and N2 are the length of filters h12 and h21 respectively.

h₁₂^{k+1}h₁₂^{k}+μ₁₂x₁(k) x̅₂(k) (3)

h₂₁^{k+1}=h₂₁^{k}+μ₂₁x₂(k) x̅₁(k)

And the step-sizes for each filter are given as following.

$${μ}_{12} = \frac{2 {α}_{12}}{{N}_{1} var ( {y}_{1} ) + {N}_{2} var ( {y}_{2} )} \\ {μ}_{21} = \frac{2 {α}_{21}}{{N}_{2} var ( {y}_{2} ) + {N}_{1} var ( {y}_{1} )} \qquad ( 4 )$$

The echo filters H₁₃(z) and H₂₃(z) may be estimated by Normalized Least Square (NMLS) algorithm. The stereo VAD outputs are referred to select filters to be adapted and their adaptation scheme. FIG. 4 is an embodiment of an echo filter adaptation. FIG. 4 depicts the echo filters that have the paths from echo reference channel to primary and reference channels, which may affect the output of cross-talk and noise leakage filters, as shown in FIG. 4.

The echo filters H₁₃(z) and H₂₃(z) are updated in time domain by the equations as follows,

$${h}_{12}^{k + 1} = {h}_{13}^{k} + {μ}_{13} E \{ {y}_{3}^{k} \cdot {e}_{2}^{{k}^{*}} \} \\ {h}_{23}^{k + 1} = {h}_{23}^{k} + {μ}_{23} E \{ {y}_{3}^{k} \cdot {e}_{1}^{{k}^{*}} \} \\ where , \\ E \{ {y}_{3}^{k} \cdot {e}_{m}^{{k}^{*}} \} = \frac{1}{N} {\sum }_{i = 0}^{N - 1} {y}_{3}^{( k - i )} \cdot {e}_{m}^{{( k - i )}^{*}} , m = 1 , 2 \qquad ( 5 )$$

and the step-sizes for each filter will be updated by the following equations.

$${μ}_{13} = \frac{{β}_{13}}{var ( {y}_{3} )} \\ {μ}_{23} = \frac{{β}_{23}}{var ( {y}_{3} )} \qquad ( 6 )$$

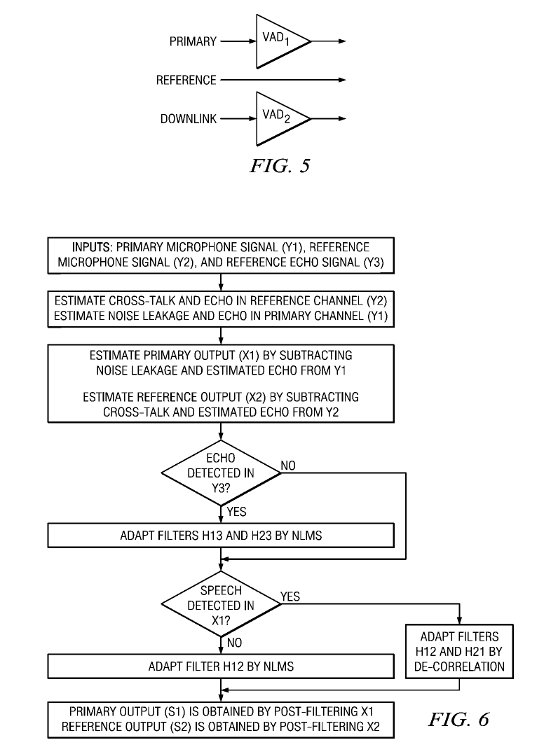

Since different filter adaptation methods de-correlation and NLMS may be used inside the proposed algorithm, VAD outputs from primary and echo reference channel inputs play important role in the filter adaptation scheme. Two channel VAD outputs may be used to decide which filter should be adapted based on certain primary and echo reference inputs. FIG. 5 is an embodiment of a two channel Voice Activity Detector (VAD) outputs from primary and echo reference channel inputs. FIG. 5 illustrates the VAD outputs from each input.

There are a series of scenario for filter adaptation scheme using VAD output, however, approachable cases are selected. Table 1 shows the filter adaptation scheme for adapting filters in the CTR-ANEC. Some cases may not happen in real world. For example, pure speech only and echo only cases may not be expected on primary channel inputs.

TABLE 1

| | | Filter | |
|---|---|---|---|
| Case | Filter to be adapt | to be frozen | Adaptation Type |
| Noise Only | H12 | H21, H13, H23 | NLMS |
| Speech + Noise | H12, H21 | H13, H23 | De-correlation |
| Echo + Noise | H12, H13, H23 | H21 | H12: NLMS |
| | | | H13 & H23: NLMS |
| Double-talk + | H12, H21, | — | H12 & H21: |
| Noise | H13, H23 | | De-correlation |
| | | | H13 & H23: NLMS |

As shown in Table 1, a filter adaptation for the case of double-talk and noise primary input. From the Table 1, all of the four filters are adapted in the CTR-ANEC. In the real world implementation, the four filters may not be adapted simultaneously. Instead, in one embodiment, two filters first, Ĥ₁₂(z) and Ĥ₂₁(z) are adapted, which may be frozen. Next, the next two filters are adapted, Ĥ₁₃(z) and Ĥ₂₃(z) with the frozen filters.

FIG. 6 is a flow diagram depicting an embodiment of a method for noise and echo cancellation of a two microphone system subject to cross-talk. The primary microphone signal, the reference microphone signal and the reference echo signal are retrieved. Utilizing the retrieved signals to estimate the cross-talk and echo estimate in reference channel, noise leakage and echo estimate in primary channel. The primary output is estimated by removing the noise leakage and estimating the echo in the primary channel. Also, the reference output is estimated by removing the cross-talk and echo estimate from the reference channel. If an echo is detected in the reference echo signal, then filters H13 and H23 are adapted by NLMS. If the estimated primary output includes speech, then filters H12 and H21 are adapted by de-correlation.

If neither echo nor speech is detected, then filter H12 is adapted by NLMS. The method proceeds to obtain the primary output and the reference output by post-filtering of the estimated primary output and the estimated reference output, respectively. The primary output and the reference output are used to cancel the echo and noise of a two microphone system subject to cross-talk.

While the foregoing is directed to embodiments of the present invention, other and further embodiments of the invention may be devised without departing from the basic scope thereof, and the scope thereof is determined by the claims that follow.

What is claimed is:

1. A method of a digital processor for joint noise and echo cancellation of a two microphone system subject to cross-talk, comprising:
retrieving the primary microphone signal, the reference microphone signal and the reference echo signal;
utilizing the retrieved the primary microphone signal, the reference microphone signal and the reference echo signal to estimate the cross-talk, echo in reference channel, noise leakage and echo in primary channel;
estimating the primary output by removing the noise leakage and echo estimate from the primary channel;
estimating the reference output by removing the cross-talk and echo estimate from the reference channel;
when an echo is detected in the reference echo signal, adapting filters H13 and H23 by NLMS, when the estimated primary output includes speech, adapting filters H12 and H21 by de-correlation, when neither echo nor speech is detected, adapting filter H12 is adapted by NLMS;
obtaining the primary output and the reference output by post-filtering of the estimated primary output and the estimated reference output, respectively; and
utilizing the primary output and the reference output for canceling the echo and noise of a two microphone system subject to cross-talk.

2. An apparatus for noise and echo cancellation of a two microphone system subject to cross-talk, comprising:
means for retrieving the primary microphone signal, the reference microphone signal and the reference echo signal;
means for utilizing the retrieved the primary microphone signal, the reference microphone signal and the reference echo signal to estimate the cross-talk and echo in reference channel, noise leakage and echo in primary channel;
means for estimating the primary output by removing the noise leakage and estimating the echo of the primary channel;
means for estimating the reference output by removing the cross-talk and estimating the echo from the reference channel;
means for adapting filters H13 and H23 by NLMS;
means for adapting filters H12 and H21 by de-correlation;
means for adapting filter H12 is adapted by NLMS;
means for obtaining the primary output and the reference output by post-filtering of the estimated primary output and the estimated reference output, respectively; and
means for utilizing the primary output and the reference output for canceling the echo and noise of a two microphone system subject to cross-talk.

3. A non-transitory computer storage medium with executable instructions stored therein, when executed performs a method for noise and echo cancellation of a two microphone system subject to cross-talk, comprising:
retrieving the primary microphone signal, the reference microphone signal and the reference echo signal;
utilizing the retrieved the primary microphone signal, the reference microphone signal and the reference echo signal to estimate the cross-talk, echo in reference channel, noise leakage and echo in primary channel;
estimating the primary output by removing the noise leakage and estimating the echo of the primary channel;
estimating the reference output by removing the cross-talk and estimating the echo from the reference channel;
when an echo is detected in the reference echo signal, adapting filters H13 and H23 by NLMS, when the estimated primary output includes speech, adapting filters H12 and H21 by de-correlation, when neither echo nor speech is detected, adapting filter H12 is adapted by NLMS;
obtaining the primary output and the reference output by post-filtering of the estimated primary output and the estimated reference output, respectively; and
utilizing the primary output and the reference output for canceling the echo and noise of a two microphone system subject to cross-talk.
